(19) United States
(12) Patent Application Publication
(10) Pub. No.: US 2025/0146097 A1
(43) Pub. Date: May 8, 2025

(54) HIGH-STRENGTH HOT DIP-COATED STEEL STRIP WITH PLASTICITY BROUGHT ABOUT BY MICROSTRUCTURAL TRANSFORMATION AND METHOD FOR PRODUCTION THEREOF

(71) Applicant: Salzgitter Flachstahl GmbH, Salzgitter (DE)

(72) Inventors: Konstantin Molodov, Braunschweig (DE); Norbert Kwiaton, Salzgitter (DE)

(21) Appl. No.: 18/835,332

(22) PCT Filed: Feb. 1, 2023
(86) PCT No.: PCT/EP2023/052402

§ 371 Date: Aug. 1, 2024

(30) Foreign Application Priority Data
Feb. 2, 2022 (DE) 10 2022 102 418.0

(51) Int. Cl. C21D 9/52; B32B 15/01; C21D 6/00; C21D 8/02; C22C 38/00; C22C 38/02; C22C 38/44; C22C 38/46; C22C 38/48; C22C 38/50; C22C 38/54; C22C 38/58; C23C 2/06; C23C 2/28; C23C 2/40

(52) U.S. Cl. CPC C21D 9/52; B32B 15/013; C21D 6/004; C21D 6/005; C21D 6/008; C21D 8/0205; C21D 8/0226; C21D 8/0236; C21D 8/0263; C22C 38/001; C22C 38/002; C22C 38/02; C22C 38/44; C22C 38/46; C22C 38/48; C22C 38/50; C22C 38/54; C22C 38/58; C23C 2/06; C23C 2/28; C23C 2/40; B32B 2311/20; C21D 2211/001; C21D 2211/002; C21D 2211/008

(57) ABSTRACT

A method of producing a hot dip-coated high-strength steel strip with plasticity brought about by microstructural transformation starting from producing a hot-rolled steel strip, etching and optionally cold rolling the hot-rolled steel strip to give a cold-rolled steel strip, subsequently continuously annealing in a continuous process of hot dip coating the cold- or hot-rolled steel strip, subsequently cooling the cold- or hot-rolled steel strip to an intermediate temperature, subsequently further cooling the cold- or hot-rolled steel strip from the intermediate temperature to a cooling stop temperature within a temperature range and at an average cooling rate, and then keeping the temperature within a temperature range, then hot dip coating the cold- or hot-rolled steel strip, and cooling the hot dip coated cold- or hot-rolled steel strip at an average cooling rate to ambient temperature. The corresponding hot dip-coated high-strength steel strip thus has plasticity brought about by microstructural transformation.

### CROSS REFERENCE TO RELATED APPLICATION

The present application is a national stage application of International Patent Application No. PCT/EP2023/052402, filed Feb. 1, 2023, and claims benefit of German patent application no. 10 2022 102 418.0, filed Feb. 2, 2022.

### BACKGROUND AND FIELD OF THE INVENTION

The present invention discloses a method for producing a hot-dip coated high-strength steel strip with plasticity brought about by microstructural transformation. The invention also relates to a corresponding hot-dip coated high-strength steel strip with plasticity brought about by microstructural transformation.

In high-strength dual- and multiphase steels, the achievable elongation or ductility and thus the formability decreases as the strength class increases. However, there is a demand in the automotive industry for grades of steel which still offer high formability at high strengths in order to meet the requirement of high elongation in complex forming operations. This high formability can be achieved by plasticity brought about by microstructural transformation. Therefore, it is required to set a sufficient content of residual austenite in the microstructure.

By way of a higher content of Si, a proportion of residual austenite can stabilise in the microstructure, whereby higher elongations are achieved by the known TRIP (Transformation Induced Plasticity) effect. EP2439291B1 discloses a multiphase steel having 1.4-2.0 wt. % Si, wherein by reason of the high Si contents carbide formation is suppressed and sufficient stability of the residual austenite is achieved. In the same manner, EP3024951B1 discloses a steel sheet having a tensile strength ≥900 MPa with 1≤Si≤3 wt. %. EP3128023B1 describes a high-strength steel strip having a high yield strength ratio and Si contents between 1.2 and 2.2 wt. %. The same span of Si between 1.2 and 2.2 wt. % is also used in EP2707514B1 in order to produce a steel strip having a tensile strength >1000 MPa and a uniform elongation >12%.

However, owing to Si, during continuous galvanising the galvanising capability is clearly worsened by impairing the galvanising reaction when the steep strip is dipped into the zinc melt. In the case of high contents of Si, highly adhesive scale which impairs the surface quality and further processing can also already form in the hot strip. Si can be partially substituted by increased contents of Al in order to stabilise residual austenite. For instance, EP3394300B1 and EP3394297B1 describe for example the use of 1≤Si+Al≤2 wt. % and 1≤Si+Al≤2.2 wt. % respectively, in order to set sufficient amounts of residual austenite. In a similar manner, EP2439290B1 discloses a multiphase steel having a tensile strength of at least 950 MPa and a residual austenite content of at least 6% with Si between 0.2 and 0.7 wt. % and Al between 0.5 and 1.5 wt. %, wherein the content of Cr is <0.1 wt. %.

However, excessive contents of Al can be disadvantageous for the hot ductility or castability during continuous casting. In addition, Al increases the Ac3 transformation temperature, and so during continuous galvanising high annealing temperatures are required which are to be avoided for procedural and cost reasons. The sum of Si+Al should thus be as low as possible if a hot-dip galvanised steel strip is produced. Low Si+Al contents are also advantageous for avoiding liquid metal embrittlement. In conjunction with the invention, the terms hot-dip galvanised and hot-dip coated are used synonymously unless reference is explicitly made that the hot-dip galvanising is intended to produce a coating made from zinc or a zinc alloy.

In addition to the effect of Si and Al, EP2831299B2 describes the advantageous use of Cr in combination with Si and Al in order to produce higher contents of residual austenite having a minimum content of Si+0.8Al+Cr of 1.4 wt. % for 5-20 vol. % residual austenite. However, in addition to high costs and limitation in terms of welding suitability, a high content of Cr has the disadvantage that when a process is carried out in the typical manner the hot strip, owing to increased hardenability, can become too hard to be able to be subsequently cold-rolled to form a cold strip. Owing to the increase in hardenability, Cr likewise has a significant effect on the microstructure development during continuous hot-dip galvanising. Therefore, Cr cannot be added by alloying to any high content if a particular target microstructure is to be set. A predominantly bainitic basic microstructure requires, as the Cr content increases, a longer ageing zone in the continuous hot-dip galvanising, which cannot always be achieved on a large scale.

Document EP3730635 A1 describes a method for producing a hot-dip coated high-strength steel sheet and a corresponding hot-dip coated high-strength steel sheet, in which the actual steel sheet has a content of carbon (C) of 0.04 to at most 0.15 wt. % and a content of antimony (Sb) of 0.05 wt. % or less—except for 0 wt. %. Antimony (Sb) is added by alloying so that it—distributed in grain boundaries—delays the diffusion of oxidising elements such as Mn, Si, Al and the like through the grain boundaries. Furthermore, the actual steel sheet is characterised by a content of titanium (Ti) and/or niobium (Nb)—in each case from 0.003 to at most 0.06 wt. %—which is used to increase the strength and for grain refinement.

### SUMMARY OF THE INVENTION

The present provides a method for producing a hot-dip coated high-strength steel strip and a corresponding hot-dip coated high-strength steel strip, in which the hot-dip coated steel strip has overall a high strength in combination with a high uniform elongation with good adhesion of the coating on the actual steel strip.

In accordance with an embodiment of the invention, a method for producing a hot-dip coated high-strength steel strip with plasticity brought about by microstructural transformation comprises (i) producing a hot-rolled steel strip, in particular from a slab heated to above 1200° C., consisting of the following elements in wt. %: C: from 0.15 to 0.205; Mn: from 1.9 to 2.6; Al: from 0.2 to 0.7; Si: from 0.5 to 0.9; Cr: from 0.2 to 0.5; Nb: from 0.01 to 0.06; Mo: <0.15; B: ≤0.001; P: ≤0.02; S: ≤0.005, and optionally one or more of the following elements in wt. %: Ti: 0.005 to 0.060; V: 0.001 to 0.060; N: 0.0001 to 0.016; Ni: 0.01 to 0.5 and Cu: 0.01 to 0.3, with the remainder being iron including typical steel-associated elements, wherein for a value μ=4.5×([Si]+0.9×[Al]+[Cr])+200×[Nb], in which [Si], [Al], [Cr] and [Nb] are the proportions of the corresponding elements in wt. %, 8≤μ≤16, (ii) acid-cleaning and optionally cold-rolling the hot-rolled steel strip to form a cold-rolled steel strip, (iii) subsequently continuously annealing during a continuous hot-dip coating process of the cold- or hot-rolled steel strip at a maximum temperature between 750° C. to 950° C. inclusive, in particular between 80° and 870° C., for the total duration of 10 s to 1200 s, in particular from 50 s to 650 s, (iv) subsequently cooling the cold- or hot-rolled steel strip to an intermediate temperature in a temperature range of 620 to 760° C. at an average cooling rate CR₁ of up to 10 K/s, (v) subsequently further cooling the cold- or hot-rolled steel strip from the intermediate temperature to a cooling stop temperature in a temperature range between 200° C. and 450° C. inclusive, in particular between 280° C. and 450° C. inclusive, at an average cooling rate CR₂>CR₁ and at most 150 K/s and then maintaining the temperature in the temperature range between 200° C. and 450° C. inclusive, in particular between 280° C. and 450° C. inclusive, for 25 to 500 s, (vi) subsequently hot-dip coating the cold- or hot-rolled steel strip at a temperature between 380 and 500° C., and (vii) subsequently finally cooling the hot-dip coated cold- or hot-rolled steel strip at an average cooling rate of 1 K/s to 50 K/s to ambient temperature. Advantageous properties are produced by the proportions of the elements Si; Al; Cr and Nb and the value μ, resulting from these proportions, in combination with the described continuous hot-dip coating process. Of particular note is the proportion of the element Nb.

It is known that Nb as a microalloy element increases the strength by strong grain refinement and formation of fine Nb (C,N) precipitations. In a particular manner, this effect is used in steels having a low C content because the solubility limit of Nb, as the content of C decreases, shifts towards higher concentrations and thus a larger amount of Nb is effective. The advantageous effect of Nb in an Al-free dual-phase steel with residual austenite and an Nb content of ca. 300 ppm is described in the scientific article “Mohrbacher, J.-R. Yang, Y.-W. Chen, J. Rehrl; Metals 10 (2020) 504”. Advantages are thus described therein such as higher strength and toughness with an increase of R_{p0.2} elasticity limit and tensile strength (Rₘ) by grain refinement and nanosize Nb precipitations, more homogeneous elongation distribution in the microstructure and finer MA grain sizes to improve crack resistance. In addition, a long delay for recrystallisation of the cold-rolled microstructure was observed. With respect to the Nb content of 300 ppm, the authors would like to point out that this is the maximum possible soluble content of Nb for the examined dual-phase steel in a large-scale process because the maximum holding temperature when heating the slabs prior to hot-rolling is limited from a technological point of view. Document EP 3394300 B1 also describes the optional use of Nb in steels with the TRIP effect for grain refinement of the austenite during hot-rolling and strength increase by precipitation hardening during final annealing treatment.

However, contrary to this typical use of Nb for increasing the strength, in the steel strip produced in accordance with the invention an unexpected effect was found. In combination with Si, Al and Cr, in the steel in accordance with the invention, an increase in the Nb content results in lower strengths, but at the same time an increase in the content of residual austenite when the process is carried out in a suitable manner (FIG. 1). Despite the decrease in tensile strength as the Nb content increases, the product of tensile strength and uniform elongation Rₘ×A_{g} increased owing to the higher proportion of residual austenite. Therefore, in the steel in accordance with the invention in particular the contents of Si and Al can be kept low compared with the achieved contents of residual austenite. Therefore, the steel can be produced via the continuous hot-dip galvanising process and is characterised by a very good adhesion of the coating, i.e. in particular zinc adhesion. It was determined that the value μ=4.5×([Si]+0.9 [Al]+[Cr])+200×[Nb] in wt. % should be between 8 and 16, in particular between 8.0 and 16.0, in order to stabilise residual austenite, wherein for the reasons described the sum [Si]+0.9×[Al] is limited to <1.2 wt. %, preferably to <1.0 wt. % in order to ensure good galvanising capability.

Furthermore, it was also established that contents of Nb above 300 ppm are also effective metallurgically and increase the content of residual austenite in the final microstructure, whereby the maximum elongations can be achieved. By avoiding excessively high contents of Cr (<0.5 wt. %, more precisely <0.50 wt. %), different microstructures can be additionally set in a flexible manner, in which for example more bainite is present than tempered martensite, or vice-versa.

In the step of producing a hot-rolled steel strip, in particular from a slab heated to above 1200° C., provision is preferably made that the hot-rolled steel strip consists of the following elements in wt. %: C: from 0.15 to 0.205; Mn: from 1.90 to 2.60; Al: from 0.20 to 0.70; Si: from 0.50 to 0.90; Cr: from 0.20 to 0.50; Nb: from 0.0100 to 0.0600; Mo: <0.15; B: ≤0.0010; P: ≤0.02; S: ≤0.005, and optionally one or more of the following elements in wt. %:

Ti: 0.005 to 0.060; V: 0.001 to 0.060; N: 0.0001 to 0.016; Ni: 0.01 to 0.5 and Cu: 0.01 to 0.3, with the remainder being iron including typical steel-associated elements, wherein for a value μ=4.5×([Si]+0.9×[Al]+[Cr])+200×[Nb], in which [Si], [Al], [Cr] and [Nb] are the proportions of the corresponding elements in wt. %, 8.0≤μ≤16.0. In this indication of the composition of the steel strip, selected limits are stated more precisely in relation to their accuracy.

Provision is preferably made that 10.0≤μ≤16.0 applies for the value μ and the expression [Si]+0.9×[Al]<1.2, in particular [Si]+0.9×[Al]<1.0, applies, wherein [Si] and [Al] are the proportions of the corresponding elements in wt. % on the hot-rolled steel strip.

According to a preferred embodiment of the method in accordance with the invention, provision is made that the proportion of C on the hot-rolled steel strip is at least 0.16 wt. %, i.e. the C proportion in wt. % is in the range of 0.16 to 0.205. Provision is preferably made that the proportion of Mn on the hot-rolled steel strip is between 1.95 and 2.4 wt. %, in particular between 1.95 and 2.40 wt. %, the proportion of C on the hot-rolled steel strip is at least 0.16 wt. % and preferably the expression (100 [C]+10 [Mn])/(4.5×([Si]+0.9 [Al]+[Cr])+200×[Nb])<4.5 applies. [Si], [Al], [Cr], [C] and [Mn] are the proportions of the corresponding elements on the hot-rolled steel strip in wt. %.

Furthermore, provision is advantageously made that the sum of the proportions of the elements Cr and Mo on the hot-rolled steel strip in wt. % is less than 0.5, i.e. [Cr]+[Mo]<0.5.

According to another preferred embodiment of the method in accordance with the invention, the intermediate temperature is in a temperature range of 650 to 730° C. and the steel strip has, when this temperature is reached, a microstructure having at least 10 vol. % ferrite.

According to still another preferred embodiment of the method in accordance with the invention, the upper limit of the cooling stop temperature is 400° C., preferably 350° C., i.e. cooling stop temperature ≤400° C., preferably ≤350° C., wherein after the final cooling to ambient temperature more than 8 vol. % austenite is present in the microstructure and wherein the temperature at which the cold- or hot-rolled steel strip is kept prior to the hot-dip coating is ≤400° C., preferably ≤350° C.

Further advantages of Nb in terms of the large-scale production in the continuous hot-dip galvanising process are operation modes at higher process speeds and wider process windows for the cooling stop temperature. In the steel in accordance with the invention, the proportion of ferrite can also be set in the continuous hot-dip galvanising process in a targeted manner via the content of Nb, whereby the technological properties such as tensile strength, elasticity limit, yield strength ratio and uniform elongation can be controlled without altering the annealing cycle. Owing to the wider process window for the cooling stop temperature, larger temperature fluctuations can be tolerated during large-scale production. For instance, in a preferred embodiment with μ≥10 a fluctuation in the cooling stop temperature of ΔT in the range of 315 to 400° C. over the strip length of the steel strip results only in a maximum fluctuation in the tensile strength in the rolling direction of the hot-dip coated steel strip of 0.47×Δ in MPa (wherein the numerical value Δ corresponds to the numerical value in Kelvin of ΔT), whereby high process stability for the method is achieved.

Within the scope of the invention, a high-strength hot-dip coated steel strip having a dual- or multiphase microstructure with residual austenite for a plasticity brought about by microstructural transformation and excellent formability with A_{g}>8% and a low content of Si and Al, is provided in conjunction with the corresponding method for producing the steel strip with high process stability. Furthermore, the steel strip should preferably have good weldability and a low tendency to liquid metal embrittlement and hydrogen embrittlement. In particular, the resulting hot-dip coated high-strength steel strip has a tensile strength Rₘ of at least 900 MPa and uniform elongation A_{g} of at least 8%.

According to another preferred embodiment of the method in accordance with the invention, the hot-dip coated steel strip during or after the last method step is subjected to skin pass rolling with a rolling degree of at most 2% such that the R_{p0.2} elasticity limit increases by at least 20 MPa owing to the skin pass rolling.

Finally, in a method in accordance with the invention provision is made that in the case of the hot-rolled steel strip the content of Ti is at least 0.005 wt. %, the content of N is at most 0.008 wt. %, the content of Al is at most 0.50 wt. % and TiN and TiAlN particles having a diameter of >0.96 μm are present in total in a surface proportion of at least 1 μm²/mm² on a measuring surface of at least 100 mm² in the slab prior to re-heating and on a measuring surface of at least 20 mm² in the hot-dip coated high-strength steel strip.

Higher contents of aluminium, as also used in the steel in accordance with the invention, can result in the formation of harmful two-dimensional AlN at the primary grain boundaries during or immediately after the continuous casting process, whereby the slabs are prone to cracking (so-called AlN embrittlement). It was established that the number of these harmful AlN precipitations can be reduced in the steel in accordance with the invention by TiN and TiAlN precipitations which are non-critical for cracking susceptibility. TiN is formed partially in the melt and thus binds the nitrogen before it can react with Al to form AlN. Therefore, in order to reduce the cracking susceptibility in the slabs used the steel in accordance with the invention contains in an advantageous design TiN and TiAlN precipitations having a diameter of >0.96 μm in total in a surface proportion of at least 1 μm²/mm² on a measuring surface of at least 100 mm² in the slab prior to re-heating. Since the TiN and TiAlN no longer dissolve in the following annealing processes, they can likewise still be detected in the hot-dip coated high-strength steel strip. The proportion of TiN and TiAlN can be determined quantitatively by means of energy-dispersive X-ray spectroscopy (EDX). Contents of elements are measured in at. % in particles and the surface Aₚ of the particles, which produces the diameter as √ (4Aₚ/π). The concentration of elements in the particle (elements N, O, F, Na, Mg, Al, Si, S, K, Ca, Ti, V, Cr, Mn, Zn, Zr, Nb and Pb) is produced minus the contents of the elements Fe and C in total to form 100 at. %. TiN is characterised in that the elements with the highest and second highest concentration in the particle in at. % are from the group [Ti, N], in addition the contents of Ti and N are each >5 at. % and the content of Al is <5 at. %. For TiAlN, the elements with the highest and second highest concentration in the particle in at. % are from the group [N, Al, Ti] and the content of Ti, Al and N is >5 at. % in each case.

The production of the high-strength hot-dip coated steel strip with plasticity brought about by microstructural transformation and a microstructure consisting of ferrite, martensite, bainite and residual austenite generally takes place as follows:
(i) Producing a hot-rolled strip of variable thickness, typically between 1.7 and 6 mm, from slabs having a steel chemistry composition in accordance with the invention, which was necessarily reheated prior to hot-rolling to a temperature >1200° C. in order to dissolve Nb. The final rolling temperature during hot-rolling is between 86° and 960° C. and is typically >900° C. in order to avoid thermomechanical rolling and microstructure inhomogeneities.

The reeling temperature can be between 42° and 750° C. and is typically >600° C. in order to set a predominantly ferritic-pearlitic hot strip microstructure.
(ii) Acid-cleaning and optionally batch-type annealing the hot strip at a maximum holding temperature between 40° and 700° C. for an annealing duration of 12 h to 6 days, wherein the annealing duration includes the time for heating and cooling to room temperature.

Primarily, the batch-type annealing can be performed when the hot strip was reeled at temperatures <600° C. in order to reduce the resistance during cold-rolling. In connection with the present invention, room temperature or ambient temperature is understood to mean a temperature between 10 to 40° C., preferably 15 to 25° C. Optionally cold-rolling the hot strip to form a cold strip or referred to as fine sheet to a thickness of typically 0.5 mm to 2.5 mm.
(iii) Continuous annealing during continuous hot-dip galvanising the cold- or hot-rolled strip at a temperature between 75° and 950° C., preferably >800° C., in order to set a high degree of austenitisation.
(iv) First slow cooling in the system segment of slow cooling (so-called slow cooling path) to an intermediate temperature of 620 to 760° C., preferably 650 to 730° C. in order to form ferrite. In addition to the residual austenite, ferrite contributes as a soft phase to higher ductility of the steel strip. The intermediate temperature is to be selected such that the final microstructure contains at least 10% ferrite. Owing to the high C and Mn content of the steel in accordance with the invention, the hardenability is increased so much that in the region of the slow cooling path with virtually complete austenitisation taking place and at higher process speeds or higher cooling rates in the slow cooling path, the formation of ferrite occurs only insufficiently when <100 ppm Nb is alloyed. By alloying with Nb in the steel in accordance with the invention, the formation of ferrite is permitted in the region of the slow cooling path even at higher process speeds or high cooling rates, resulting therefrom, in the slow cooling path such as 4 K/s. For this reason, the Nb content of at least 100 ppm Nb is absolutely necessary and permits system configurations with a short segment of the slow cooling path or high process speeds for increasing the throughput.
(v) Second rapid cooling in the system segment of rapid cooling from the intermediate temperature to a cooling stop temperature between 200° C. and 450° C., in particular between 280° C. and 450° C. Maintaining an ageing temperature between 200° C. and 450° C., in particular between 280° C. and 450° C., preferably for instance equal to the cooling stop temperature, whereby the concentration of carbon in the residual austenite is increased and the residual austenite in the final microstructure remains stable even at room temperature. An advantage of approximately equal cooling stop and ageing temperature lies in the use of hot-dip galvanising systems which do not have a reheating unit directly after reaching the cooling stop temperature. This permits flexible production of the steel in accordance with the invention with different system configurations. Lower cooling stop and ageing temperatures typically result in higher strengths, but to the detriment of the residual austenite content. In this context, in the steel in accordance with the invention it was established that at a higher content of Nb>100 ppm, in particular 200-600 ppm, at a low cooling stop temperature and the same ageing temperature of ≤400° C., in particular ≤350° C., a high content of residual austenite can still be set which is not possible without Nb. In addition, the achievable contents of residual austenite are aligned for different cooling stop temperatures at a higher Nb content and permit larger process windows and constant technological properties in terms of the plasticity brought about by microstructure transformation. Low cooling stop temperatures of ≤400° C., in particular ≤350° C., are additionally advantageous in forming tempered martensite and thus setting an associated higher elasticity limit and allowing harmful hydrogen to diffuse from the steel from the production process when maintaining this temperature. At excessive cooling stop temperatures of >450° C., the martensite transformation occurs only after the hot-dip coating and the hydrogen is trapped by the hot-dip coat. Also, at insufficient cooling stop and ageing temperatures of <200° C. the result is that hydrogen is trapped since the diffusion of the hydrogen is prevented at low temperatures. Likewise, insufficient cooling stop temperatures of <200° C. result in an excessive proportion of tempered martensite and thus in an excessive yield strength ratio of the steel strip and require very high cooling capacities. Therefore, the minimum cooling stop and ageing temperature is 200° C., preferably 280° C., in order to set optimum proportions of bainite and tempered martensite and to permit diffusion of hydrogen from the steel strip.
(vi) Optionally reheating the steel strip and performing hot-dip finishing at a temperature between 38° and 500° C. The step of hot-dip finishing is an integral component during the process of producing the steel in accordance with the invention since not only is a hot-dip coating applied to the steel surface but the final technological characteristic values of the hot-dip coated steel strip are also influenced by the heat treatment in this step. If martensite is already formed in the microstructure prior to reheating of the steel strip, then this martensite is tempered during the hot-dip finishing and is thus referred to as tempered martensite.
(vii) Then, cooling of the coated steel strip to ambient temperature takes place. During final cooling to ambient temperature, the insufficiently stabilised austenite is converted to martensite (fresh martensite). The remaining austenite is referred to as residual austenite. Optional skin pass rolling and/or stretch-bend-straightening of the coated steel strip in order to finally set the R_{p0.2} elasticity limit.

The alloying concept and the processing of the steel strip in accordance with the invention are aimed at achieving high tensile strengths >900 MPa and a residual austenite content of >8 vol. % in order to guarantee excellent formability. The microstructure of the steel strip in accordance with the invention is composed of 8-16 vol. % residual austenite, >10 and <40 vol. % ferrite, at least a sum of 50 vol. % of bainite, tempered and fresh martensite, wherein in a preferred embodiment, in total more bainite and fresh martensite is present than tempered martensite. The percentages stated for the microstructure components for ferrite, bainite and martensite were determined in the longitudinal polished section perpendicular to the rolling surface and refer to the surface proportions (surface spanned by sheet normal and rolling direction) which typically are also adopted as volume proportions. Furthermore, the microstructure proportions refer to the ¼ position over thickness. The residual austenite content can be measured by means of a magnet-inductive method by means of a magnetising yoke. Alternatively, the proportion of residual austenite can also be determined by means of X-ray diffraction or with electron backscatter diffraction (EBSD) on electropolished samples.

Fresh martensite has a high dislocation density and high hardness by reason of its formation mechanism. In the case of electron backscatter diffraction, such regions appear darker than other microstructure components in the Kikuchi band contrast because the diffraction condition is adversely affected by a disturbed crystal lattice. From this, the proportion of fresh martensite can be quantitatively determined. Alternatively, the formation of fresh martensite can be established with the aid of the dilatometry on the basis of the change in volume when a sample is cooled.

The invention also relates to a hot-dip coated high-strength steel strip with a plasticity brought about by microstructural transformation, in particular produced in accordance with the method stated above, consisting of the following elements in wt. %: C: from 0.15 to 0.205; Mn: from 1.9 to 2.6; Al: from 0.2 to 0.7; Si: from 0.5 to 0.9; Cr: from 0.2 to 0.5; Nb: from 0.01 to 0.06; Mo: <0.15; B: ≤0.001; P: ≤0.02; S: ≤0.005, and optionally one or more of the following elements in wt. %: Ti: 0.005 to 0.060; V: 0.001 to 0.060; N: 0.0001 to 0.016; Ni: 0.01 to 0.5 and Cu: 0.01 to 0.3; with the remainder being iron including typical steel-associated elements. Provision is made that for a value μ=4.5×([Si]+0.9×[Al]+[Cr])+200×[Nb], in which [Si], [Al], [Cr] and [Nb] are the proportions of the corresponding elements in wt. %, 8≤μ≤16, wherein the steel strip has a product of Rₘ tensile strength and uniform elongation A_{g} of greater than 8000 MPa %, in particular greater than 9000 MPa %, and particularly advantageously between 9900 to 13000 MPa %.

For the steel of the actual steel strip, provision is preferably made that this consists of the following elements in wt. %: C: from 0.15 to 0.205; Mn: from 1.90 to 2.60; Al: from 0.20 to 0.70; Si: from 0.50 to 0.90; Cr: from 0.20 to 0.50; Nb: from 0.0100 to 0.0600; Mo: <0.15; B: ≤0.0010; P: ≤0.02; S: ≤0.005, and optionally one or more of the following elements in wt. %: Ti: 0.005 to 0.060; V: 0.001 to 0.060; N: 0.0001 to 0.016; Ni: 0.01 to 0.5 and Cu: 0.01 to 0.3; with the remainder being iron including typical steel-associated elements. Provision is made that for a value μ=4.5×([Si]+0.9×[Al]+[Cr])+200×[Nb], in which [Si], [Al], [Cr] and [Nb] are the proportions of the corresponding elements in wt. %, 8.0≤μ≤16.0. In this indication of the composition of the steel strip, selected limits are stated more precisely in relation to their accuracy.

The preferred embodiments stated in conjunction with the method for producing a hot-dip coated high-strength steel strip are to apply analogously also to the hot-dip coated high-strength steel strip. For example, for the steel of the actual steel strip provision is made in particular that the proportion of C on this steel strip is at least 0.16 wt. %, i.e. the C proportion in wt. % is in the range of 0.16 to 0.205.

The coating produced by the hot-dip coating/hot-dip galvanising is for example a coating consisting of zinc or a zinc alloy such as zinc-aluminium or zinc-aluminium-magnesium. Such coatings are well known and shall not be discussed here in further detail. The indications mentioned in conjunction with the invention and relating to the composition and microstructure of the hot-dip coated high-strength steel strip relate only to the actual steel strip used as a substrate for the coating.

According to a preferred embodiment of the hot-dip coated high-strength steel strip in accordance with the invention, the surface proportion of specific Σ3 grain boundaries having a maximum deviation of 10° to the Σ3 orientation relation of 60° <111>, relating to the overall grain boundary surface for large-angle grain boundaries having a disorientation angle >15°, is less than 30% of the grain boundaries as a whole. Furthermore, provision is advantageously made that the hot-dip coated high-strength steel strip has a yield strength ratio R_{p0.2}/Rₘ of <0.87 and a bake-hardening value BH2 of ≥25 MPa.

According to a further preferred embodiment of the hot-dip coated high-strength steel strip in accordance with the invention, the microstructure of the actual steel strip has at least the following components: 8-16 vol. % residual austenite, >10 and <40 vol. % ferrite, at least a sum of 50 vol. % of bainite, tempered martensite and fresh martensite. The phrase “actual steel strip” is to be understood to mean the steel strip used as the substrate for the coating.

According to a still further preferred embodiment of the hot-dip coated high-strength steel strip in accordance with the invention, the microstructure of the actual steel strip has at least two of the following properties: The proportion of bainite and fresh martensite in vol. % is, in total, greater than the proportion of tempered martensite in vol. %; With regard to the bainite, the proportion of granular bainite in vol. % is higher than the proportion of lower bainite in vol. %; and there is a proportion of at least 2 vol. % of fresh martensite in the total microstructure.

The effect of the elements in the high-strength steel strip in accordance with the invention with plasticity brought about by microstructural transformation will be described in greater detail hereinafter. Associated elements are unavoidable and, if necessary, are taken into consideration in the analysis concept in terms of their effect. Associated elements are elements which are already present in the iron ore or get into the steel as a result of the production process. They are generally undesired by reason of their predominantly negative influences. The attempt is made to remove them to a tolerable content level or to convert them into less harmful forms.

Nitrogen (N) is an associated element from the production of steel. Steels with free nitrogen tend to have a strong ageing effect. The nitrogen diffuses even at low temperatures to dislocations and blocks same. It thus produces an increase in strength associated with a rapid loss of toughness. Binding of the nitrogen in the form of nitrides is possible e.g. by addition by alloying of aluminium or titanium. For the reasons stated above, the optional nitrogen content is limited to ≤0.016 wt. % or to quantities which are unavoidable in the production of steel. In particular, a nitrogen content of at most 0.008 wt. % is advantageous in order to avoid harmful AlN precipitations.

Sulphur (S), like phosphorous, is bound as a trace element in the iron ore. It is not desirable in steel (the exception being machining steels) because it exhibits a strong tendency towards segregation and has a greatly embrittling effect. An attempt is therefore made to achieve amounts of sulphur in the melt which are as low as possible (e.g. by deep vacuum treatment). Furthermore, the sulphur present is converted by the addition of manganese into the relatively innocuous compound manganese sulphide (MnS). The manganese sulphides are often rolled out in lines during the rolling process and function as nucleation sites for the conversion. Primarily in the case of a diffusion-controlled conversion this produces a microstructure of pronounced lines and, in the case of a highly pronounced line formation, can result in impaired mechanical properties (e.g. pronounced martensite lines instead of distributed martensite islands, anisotropic material behaviour, reduced elongation at fracture). For the reasons stated above, the sulphur content is limited to ≤0.005 wt. % or to quantities which are unavoidable in the production of steel.

Phosphorous (P) is a trace element from the iron ore and is dissolved in the iron lattice as a substitution atom. Phosphorus increases hardness by means of mixed crystal hardening and improves hardenability. However, attempts are generally made to lower the phosphorus content as much as possible because inter alia it exhibits a strong tendency towards segregation owing to its low diffusion rate and greatly reduces the level of toughness. The attachment of phosphorous to the grain boundaries causes grain boundary fractures. Moreover, phosphorous increases the transition temperature from tough to brittle behaviour up to 300° C. During hot-rolling, near-surface phosphorous oxides at the grain boundaries can result in the formation of fractures. The addition by alloying of small quantities of boron can partially compensate for the negative effects of phosphorus. It is believed that boron increases grain boundary cohesion and reduces phosphorus segregation at grain boundaries. However, in some steels owing to the low costs and high increase in strength, it is used in small quantities (<0.1%) as a microalloy element, e.g. in higher-strength IF steels (interstitial free). For the reasons stated above, the phosphorous content is limited to ≤0.02% or to quantities which are unavoidable in the production of steel.

Alloy elements are generally added to the steel in order to influence specific properties in a targeted manner. An alloy element can thereby influence different properties in different steels. The correlations are varied and complex. The effect of the alloy elements will be discussed in greater detail hereinafter.

Carbon (C) is considered to be the most important alloy element in steel. Its targeted introduction in an amount up to 2.06% turns iron first into steel. The carbon proportion is often drastically reduced during the production of steel. Carbon is interstitially dissolved in the iron lattice owing to its comparatively small atomic radius. The solubility is at most 0.02% in the α-iron and is at most 2.06% in the γ-iron. In dissolved form, carbon considerably increases the hardenability of steel. The different solubility makes pronounced diffusion procedures necessary during the phase conversion, which procedures can result in very different kinetic conditions. Moreover, carbon increases the thermodynamic stability of the austenite, which is demonstrated in the phase diagram in an extension of the austenite region at lower temperatures and it allows higher contents of residual austenite to be stabilised at room temperature in the microstructure. As the forcibly dissolved carbon content in the martensite increases, the lattice distortions and, associated therewith, the strength of the phase produced without diffusion increase. In order to ensure sufficient strength and contents of residual austenite, the minimum C content is thus fixed to 0.15 wt. %. For the elongation, a minimum C content of 0.16 wt. % is particularly advantageous, whereby the C content increases in the residual austenite and this is stabilised to a greater extent. Since the solubility and thus the effectiveness of Nb decreases as the content of C increases, the maximum C content in the steel in accordance with the invention is limited to 0.205 wt. %. Excessive contents of C likewise prove to be typically disadvantageous for the welding suitability and liquid metal embrittlement.

Aluminium (Al) is generally added to the steel by alloying in order to bind the oxygen and nitrogen dissolved in the iron. The oxygen and nitrogen are thus converted into aluminium oxides and aluminium nitrides. These precipitations can effect grain refinement by increasing the nucleation sites and can thus increase the toughness properties and strength values. In the dissolved state, aluminium, like silicon, shifts the formation of ferrite towards shorter times and thus permits the formation of sufficient amounts of ferrite. It also suppresses the formation of carbide and thus results in a delayed conversion of the austenite. For this reason, Al is also used as an alloy element in residual austenite steels in order to substitute a part of the silicon with aluminium. The reason for this approach resides in Al being less critical for the galvanisation reaction than Si. However, Al can be disadvantageous for the hot ductility or castability during continuous casting. Al likewise causes an undesired increase in the Ac3 transformation temperature. Therefore, the Al content is limited to 0.2 wt. % to at most 0.7 wt. %, in particular 0.20 wt. % to at most 0.70 wt. %. In particular, the content of Al can be limited to at most 0.5 wt. %, in particular 0.50 wt. %, in order to avoid harmful AlN precipitations which can result in AlN embrittlement.

By means of mixed crystal hardening, silicon (Si) increases the strength and yield strength ratio of the ferrite with the elongation at fracture only decreasing slightly. A further important effect is that silicon shifts the formation of ferrite towards shorter times and therefore permits the production of ferrite prior to quench hardening. The formation of ferrite causes the austenite to be enriched with carbon and stabilised. In the case of higher contents, silicon markedly stabilises the austenite in the low temperature range specifically in the region of bainite formation by preventing the formation of carbide. During hot rolling, highly adhesive scale which can impair further processing can form at high silicon contents. In the case of continuous galvanising, silicon can diffuse to the surface during annealing and can form film-like oxides alone or together with manganese. These oxides worsen the galvanising capability by impairing the galvanising reaction (iron dissolution and inhibition layer formation) when the steel strip is dipped into the zinc melt. This is manifested in a poor zinc adhesion and non-galvanised regions. However, by means of a suitable furnace operation with adapted moisture content in the annealing gas and/or by means of a low Si/Mn ratio and/or by using moderate amounts of silicon, it is possible to ensure good galvanising capability of the steel strip and good zinc adhesion. For the reasons stated above, the minimum Si content is fixed to 0.50 wt. % and the maximum Si content is fixed to 0.90 wt. %.

Manganese (Mn) is added to almost all steels for the purpose of desulphurisation in order to convert the noxious sulphur into manganese sulphides. Moreover, by means of mixed crystal hardening manganese increases the strength of the ferrite and shifts the conversion towards lower temperatures. A main reason for adding manganese by alloying is the considerable improvement in the hardenability. By reason of the inhibition of diffusion, the pearlite and bainite conversion is shifted towards longer times and the martensite starting temperature is decreased. Manganese, like silicon, tends to form oxides on the steel surface during the annealing treatment. In dependence upon the annealing parameters and the contents of other alloy elements (in particular Si and Al) manganese oxides (e.g. MnO) and/or Mn mixed oxides (e.g. Mn2SiO4) can occur. However, manganese is to be considered to be less critical in a small Si/Mn or Al/Mn ratio because globular oxides are more likely to form instead of oxide films. Nevertheless, high manganese contents can negatively influence the appearance of the zinc layer and the zinc adhesion. The Mn content is thus fixed to 1.9 wt. % to 2.6 wt. %, in particular to 1.90 wt. % to 2.60 wt. %, preferably only up to 2.40 wt. %, in order to avoid Mn line formation.

Chromium (Cr): the addition of chromium mainly improves the hardenability. Chromium in the dissolved state shifts the pearlite and bainite conversion towards longer times and at the same time lowers the martensite starting temperature. A further important effect is that chromium considerably increases the tempering resistance and so in the zinc bath there is almost no loss of strength. Moreover, chromium is a carbide forming agent. Should chromium be present in carbide form, the austenitising temperature must be selected, prior to hardening, to be high enough to dissolve chromium carbides. Otherwise, the increased number of nuclei can cause a deterioration in the hardenability. Chromium likewise tends to form oxides on the steel surface during the annealing treatment, as a result of which the galvanising quality can be impaired. Therefore, the Cr content is fixed to values of 0.2 to 0.5 wt. %, in particular 0.20 to 0.50 wt. %.

Molybdenum (Mo): the addition of molybdenum is effected, in a similar manner to the addition of chromium, to improve hardenability. The pearlite and bainite conversion is shifted towards longer times and the martensite starting temperature is decreased. Moreover, molybdenum considerably increases the tempering resistance so that no losses in strength are to be expected in the zinc bath and effects an increase in strength of the ferrite owing to mixed crystal hardening. The Mo content is added in dependence upon the dimension, the system configuration and the microstructure setting. However, by slowing the C diffusion, Mo can also counteract the enrichment of the carbon in the residual austenite. High Mo contents also result in a high strength of the hot strip, whereby the cold-rollability is negatively influenced. For these reasons, the Mo content is fixed to up to 0.15 wt. %.

Copper (Cu): the addition of copper can increase the tensile strength and the hardenability. In conjunction with nickel, chromium and phosphorous, copper can form a protective oxide layer on the surface which can considerably reduce the corrosion rate. In conjunction with oxygen, copper can form, at the grain boundaries, noxious oxides which can produce negative effects particularly for hot-deformation processes. Therefore, the optional content of copper is limited to 0.01 to 0.3 wt. %.

Nickel (Ni): The tensile strength and hardenability can be increased by nickel. However, in conjunction with oxygen, nickel can form, at the grain boundaries, noxious oxides which can produce negative effects particularly for hot-deformation processes. Therefore, the optional content of nickel is limited to 0.01 to 0.5 wt. %.

Microalloy elements are generally added only in very small amounts (<0.1%). In contrast to the alloy elements, they mainly act by precipitate formation but can also influence the properties in the dissolved state. Despite the small amounts added, microalloy elements greatly influence the production conditions and the processing properties and final properties. In general, carbide and nitride forming agents which are soluble in the iron lattice are used as microalloy elements. Formation of carbonitrides is likewise possible by reason of the complete solubility of nitrides and carbides in one another. The tendency to form oxides and sulphides is generally most pronounced with the microalloy elements, but generally is specifically prevented by reason of other alloy elements. This property can be used positively by binding the generally harmful elements sulphur and oxygen. However, the binding can also have negative effects if, as a result, there are no longer sufficient microalloy elements available for the formation of carbides. Typical microalloy elements are vanadium, titanium, niobium and boron. These elements can be dissolved in the iron lattice and form carbides and nitrides with carbon and nitrogen respectively.

Titanium (Ti) forms very stable nitrides (TiN) and sulphides (TiS2) even at high temperatures. They only partly dissolve in the melt in dependence upon the nitrogen content. If the thus produced precipitations are not removed with the slag, they form coarse particles in the material owing to the high formation temperature and are generally not conducive to the mechanical properties. A positive effect on the toughness is produced by binding of the free nitrogen and oxygen. Therefore, titanium protects other dissolved microalloy elements such as niobium against being bound by nitrogen. These can then optimally demonstrate their effect. Titanium also acts to support the avoidance of harmful AlN precipitations which, in the present steel in accordance with the invention, can result in AlN embrittlement owing to the comparatively high contents of Al. Non-bound titanium forms, at temperatures from 1150° C., titanium carbides and can thus effect grain refinement (inhibition of the austenite grain growth, grain refinement by delayed recrystallisation and/or increase in the number of nuclei in a/y conversion) and precipitation hardening. The optional Ti content thus has values of 0.005 to 0.060 wt. %.

Niobium (Nb) typically effects considerable grain refinement because it effects a delay in the recrystallisation most effectively among all micro-alloy elements and additionally impedes the austenite grain growth. A further effect of the niobium is the delay of the a/y conversion and the reduction of the martensite starting temperature in the dissolved state. In principle, the addition of niobium by alloying is limited until its solubility limit is reached. Although this limits the amount of precipitations, it primarily effects an early formation of precipitation with quite coarse particles when said limit is exceeded. The precipitation hardening can thus become effective in real terms primarily in steels with a low C content (higher supersaturation possible) and in hot deformation processes (deformation-induced precipitation). As described above, in the hot-dip coated steel strip in accordance with the invention it was established that higher contents of residual austenite can be stabilised by Nb. The particular effect of Nb in the steel in accordance with the invention will be explained in more detail hereinafter. The Nb content is thus limited to values of 0.01 to 0.06 wt. %, in particular 0.0100 to 0.0600 wt. %, and in the present invention is particularly effective from contents of 0.0200 wt. %, and even more advantageously from 0.0300 wt. %. Therefore, in the present invention Nb is not optional and must necessarily be added by alloying.

Vanadium (V): the carbide and nitride formation by vanadium first begins at temperatures from about 1000° C. or even after the a/y conversion, i.e. substantially later than for titanium and niobium. Vanadium thus barely has a grain-refining effect owing to the low number of precipitations provided in the austenite. The austenite grain growth is also not hindered by the late precipitation of the vanadium carbides. Therefore, the strength-increasing effect is based virtually exclusively on the precipitation hardening. However, when dissolved, vanadium also has a transformation-delaying effect. One advantage of the vanadium is the high solubility in the austenite and the high volume proportion of fine precipitations caused by the low precipitation temperature. Therefore, the optional V content is fixed to values of 0.001 to 0.060 wt. %.

Boron (B) forms nitrides and carbides with nitrogen and with carbon respectively; however, this is generally not desired. On the one hand, only a low amount of precipitations are formed owing to the low solubility and on the other hand these are mostly precipitated at the grain boundaries. An increase in hardness at the surface is not achieved (the exception being boronising with formation of FeB and Fe2B in the edge zone of a workpiece). To prevent nitride formation, an attempt is generally made to bind the nitrogen by means of more affine elements. In particular, titanium can ensure the binding of all of the nitrogen. In the dissolved state, in very small amounts, boron results in a considerable improvement in the hardenability. The mechanism of action of boron can be described in such a way that boron atoms accumulate at the grain boundaries under suitable temperature control and at that location, by lowering the grain boundary energy, significantly hamper the formation of ferrite nuclei capable of growth. When controlling the temperature, care must be taken to ensure that boron is predominantly distributed atomically in the grain boundary and is not present in the form of precipitations by reason of excessively high temperatures. The efficacy of boron is decreased as the grain size increases and the carbon content increases (>0.8%). An amount over 60 ppm additionally causes decreasing hardenability because boron carbides act as nuclei on the grain boundaries. Boron diffuses extraordinarily well by reason of the small atomic diameter and has an extremely high affinity to oxygen which can lead to a reduction in the boron content in regions near to the surface (up to 0.5 mm). In this connection, annealing at over 1000° C. is discouraged. This is also to be recommended because boron can result in an excessive coarse grain formation at annealing temperatures above 1000° C. Boron is an extremely critical element for the process of continuous hot-dip finishing with zinc, as it can form film-like oxides on the steel surface even in the smallest amounts alone or together with manganese during the annealing treatment. These oxides passivate the strip surface and prevent the galvanising reaction (iron solution and inhibition layer formation). Whether film-like oxides form depends both upon the amount of free boron and manganese and upon the annealing parameters used (e.g. moisture content in the annealing gas, annealing temperature, annealing time). Higher manganese contents and long annealing times tend to result in globular and less critical oxides. Moreover, by means of an increased moisture content in the annealing gas, it is possible to reduce the amount of boron-containing oxides on the steel surface. For the reasons stated above, the B content is kept as low as possible and is limited to values up to 0.0010 wt. %.

A comparison of the alloy composition of the reference steels and the example steels in accordance with the invention is shown in Table 1. The respective composition relates in the final product to the actual steel strip, i.e. the substrate for the coating.

TABLE 1
Chemical composition of the examined steels A-U

| | | | | | | | | | | | | | | | μ = 4.5 × | | in |
|---|---|---|---|---|---|---|---|---|---|---|---|---|---|---|---|---|---|
| | | | | | | | | | | | | | | | (Si + | | accor- |
| | | | | | | | | | | | | | | | 0.9Al + | | dance |
| | analytical comparison/chemical composition (wt. %) | | | | | | | | | | | | | Si + | Cr) + | (100C + | with the |
| Steel | C | Si | Mn | P | N | Al | Cr | Ni | Mo | Ti | V | Nb | B | 0.9Al | 200 × Nb | 10Mn)/μ | invention |
| A | 0.168 | 0.63 | 2.12 | 0.006 | 0.006 | 0.323 | 0.31 | 0.037 | 0.003 | 0.001 | 0.004 | 0.001 | 0.0003 | 0.92 | 5.7 | 6.6 | No |
| B | 0.171 | 0.64 | 2.16 | 0.007 | 0.006 | 0.324 | 0.31 | 0.037 | 0.003 | 0.001 | 0.004 | 0.015 | 0.0005 | 0.93 | 8.6 | 4.5 | Yes |
| C | 0.176 | 0.65 | 2.15 | 0.007 | 0.006 | 0.323 | 0.31 | 0.037 | 0.003 | 0.001 | 0.004 | 0.024 | 0.0004 | 0.94 | 10.4 | 3.7 | Yes |
| D | 0.181 | 0.66 | 2.17 | 0.006 | 0.006 | 0.329 | 0.31 | 0.037 | 0.003 | 0.002 | 0.004 | 0.035 | 0.0004 | 0.96 | 12.7 | 3.1 | Yes |
| E | 0.181 | 0.65 | 2.13 | 0.006 | 0.006 | 0.324 | 0.31 | 0.037 | 0.003 | 0.002 | 0.004 | 0.041 | 0.0001 | 0.94 | 13.8 | 2.8 | Yes |
| F | 0.175 | 0.64 | 2.17 | 0.009 | 0.005 | 0.299 | 0.32 | 0.046 | 0.005 | 0.003 | 0.003 | 0.037 | 0.0001 | 0.91 | 12.9 | 3.0 | Yes |
| G | 0.159 | 0.65 | 2.31 | 0.008 | 0.005 | 0.299 | 0.32 | 0.045 | 0.005 | 0.003 | 0.003 | 0.014 | 0.0005 | 0.92 | 8.4 | 4.7 | Yes |
| H | 0.209 | 0.65 | 2.30 | 0.008 | 0.005 | 0.297 | 0.32 | 0.045 | 0.005 | 0.003 | 0.003 | 0.014 | 0.0003 | 0.91 | 8.4 | 5.2 | No |
| I | 0.170 | 0.67 | 2.19 | 0.008 | 0.005 | 0.326 | 0.32 | 0.044 | 0.005 | 0.003 | 0.003 | 0.013 | 0.0005 | 0.96 | 8.4 | 4.6 | Yes |
| J | 0.192 | 0.67 | 2.20 | 0.008 | 0.005 | 0.325 | 0.32 | 0.044 | 0.005 | 0.003 | 0.003 | 0.014 | 0.0004 | 0.97 | 8.6 | 4.8 | Yes |
| K | 0.186 | 0.66 | 2.17 | 0.008 | 0.005 | 0.713 | 0.40 | 0.044 | 0.005 | 0.003 | 0.003 | 0.013 | 0.0004 | 1.31 | 10.3 | 3.9 | No |
| L | 0.151 | 0.55 | 1.99 | 0.009 | 0.005 | 0.039 | 0.32 | 0.046 | 0.005 | 0.003 | 0.003 | 0.014 | 0.0004 | 0.59 | 6.9 | 5.1 | No |
| M | 0.155 | 0.87 | 2.17 | 0.008 | 0.005 | 0.299 | 0.32 | 0.045 | 0.207 | 0.034 | 0.004 | 0.042 | 0.0003 | 1.14 | 15.0 | 2.5 | No |
| N | 0.154 | 0.86 | 2.16 | 0.008 | 0.005 | 0.298 | 0.32 | 0.045 | 0.206 | 0.034 | 0.072 | 0.042 | 0.0002 | 1.13 | 14.9 | 2.5 | No |
| O | 0.154 | 0.86 | 2.17 | 0.008 | 0.005 | 0.297 | 0.32 | 0.045 | 0.107 | 0.004 | 0.003 | 0.019 | 0.0004 | 1.13 | 10.3 | 3.6 | Yes |
| P | 0.155 | 0.87 | 2.18 | 0.008 | 0.005 | 0.303 | 0.32 | 0.045 | 0.107 | 0.034 | 0.004 | 0.02 | 0.0004 | 1.14 | 10.6 | 3.5 | Yes |
| Q | 0.148 | 0.25 | 2.34 | 0.008 | 0.005 | 0.048 | 0.32 | 0.045 | 0.004 | 0.003 | 0.003 | 0.014 | 0.0006 | 0.29 | 5.6 | 6.9 | No |
| R | 0.149 | 0.25 | 2.32 | 0.008 | 0.005 | 0.049 | 0.32 | 0.045 | 0.005 | 0.033 | 0.003 | 0.014 | 0.0004 | 0.29 | 5.6 | 6.8 | No |
| S | 0.177 | 0.25 | 2.27 | 0.009 | 0.005 | 0.047 | 0.32 | 0.046 | 0.004 | 0.003 | 0.003 | 0.014 | 0.0007 | 0.29 | 5.6 | 7.3 | No |
| T | 0.203 | 0.52 | 2.28 | 0.009 | 0.005 | 0.048 | 0.32 | 0.046 | 0.004 | 0.003 | 0.003 | 0.014 | 0.0005 | 0.56 | 6.8 | 6.4 | No |
| U | 0.178 | 0.64 | 2.18 | 0.009 | 0.003 | 0.359 | 0.33 | 0.032 | <0.01 | 0.018 | 0.002 | 0.035 | 0.0003 | 0.97 | 12.8 | 3.1 | Yes |

Table 2 contains the process parameters for different annealing cycles of the process step of continuous annealing with hot-dip coating, in which the technological characteristic values (in longitudinal direction/rolling direction) are set.

TABLE 2
Process parameters for continuous annealing

| Annealing | T_{An} | t_{An} | Tₘ | CR₁ | T_{q =} T_{OA} | CR₂ | | T_{HD} | CR₃ |
|---|---|---|---|---|---|---|---|---|---|
| cycle | (° C.) | (s) | (° C.) | (K/s) | (° C.) | (K/s) | t_{oA} (s) | (° C.) | (K/s) |
| Ia | 850 | 383 | 715 | 2 | 315 | 26 | 98 | 460 | 5 |
| Ib | 850 | 240 | 715 | 4 | 315 | 42 | 61 | 460 | 7 |
| Ic | 850 | 383 | 670 | 3 | 315 | 23 | 98 | 460 | 5 |
| Id | 850 | 383 | 670 | 3 | 290 | 25 | 98 | 460 | 5 |
| Ie | 850 | 383 | 670 | 3 | 260 | 27 | 98 | 460 | 5 |
| II | 850 | 383 | 715 | 2 | 400 | 20 | 98 | 460 | 5 |
| III | 850 | 383 | 715 | 2 | 450 | 17 | 98 | 460 | 5 |
| IV | 850 | 348 | 780 | 1 | 380 | 28 | 89 | 460 | 5 |

In Table 2, the following parameters are noted:
T_{An}: annealing temperature
t_{An}: annealing duration
Tₘ: intermediate temperature
CR₁: average cooling rate during cooling from T_{An} to Tₘ
T_{q}: cooling stop temperature
T_{OA}: ageing temperature
CR₂: average cooling rate during cooling from Tₘ to T_{q}
t_{OA}: holding time at T_{OA}
T_{HD}: temperature of hot-dip finishing
CR₃: average cooling rate after hot-dip finishing

Corresponding technological characteristic values and microstructure composition for the respective steels with different annealing cycles are summarised in Table 3.

TABLE 3
Comparison of parameters of the respective hot-dip coated steel strip for the individual steels and the annealing process parameters used

| | | | | | | | | | | Σ bainite and martensite | | | | In |
|---|---|---|---|---|---|---|---|---|---|---|---|---|---|---|
| | | | | | | | | | | (fresh and tempered) | | | | accor- |
| | | | | | | | | | | | main | bainite + | Fresh | dance |
| | An- | Thick- | | | | | Rₘ × | | Fer- | | component | fresh M > | martens- | with |
| Steel | nealing | ness | R_{p0.2}⁰ | Rₘ | R_{p0.2}⁰/ | A_{g} | A_{g} | RA | rite | | (>50%) | tem- | ite | the in- |
| no. | cycle | [mm] | [MPa] | [MPa] | Rₘ | [%] | [MPa %] | [%] | [%] | | thereof | pered M | [%] | vention |
| A | Ia | 1.5 | 870 | 1015 | 0.86 | 7.2 | 7308 | 5.4 | 8 | 86.6 | tempered M | No | 3 | No |
| | II | | 700 | 975 | 0.72 | 7.9 | 7703 | 7.8 | 8 | 84.2 | bainite + fresh M | Yes | 5 | No |
| B | Ia | | 769 | 974 | 0.79 | 8.4 | 8182 | 8.8 | 16 | 75.2 | tempered M + | No | 4 | Yes |
| | | | | | | | | | | | bainite | | | |
| | II | | 589 | 926 | 0.64 | 8.7 | 8056 | 10.7 | 23 | 66.3 | bainite + fresh M | Yes | 14 | Yes |
| C | Ia | | 682 | 955 | 0.71 | 10.6 | 10123 | 10.8 | 23 | 66.2 | Bainite | Yes | 3 | Yes |
| | II | | 508 | 916 | 0.55 | 11.6 | 10626 | 12.4 | 21 | 66.6 | bainite + fresh M | Yes | 12 | Yes |
| | III | | 444 | 927 | 0.48 | >8.8* | >8158* | 11.6 | 29 | 59.4 | bainite + fresh M | Yes | 12 | Yes |
| D | Ia | | 570 | 932 | 0.61 | 11.6 | 10811 | 12.1 | 28 | 59.9 | bainite + fresh M | Yes | 5 | Yes |
| | II | | 484 | 918 | 0.53 | 12.2 | 11200 | 13.4 | 26 | 60.6 | bainite + fresh M | Yes | 14 | Yes |
| | III | | 432 | 932 | 0.46 | >8.9* | >8295* | 12.0 | 32 | 56.0 | bainite + fresh M | Yes | 12 | Yes |
| E | Ia | | 479 | 921 | 0.52 | 12.4 | 11420 | 13.7 | 31 | 55.3 | bainite + fresh M | Yes | 7 | Yes |
| | II | | 442 | 907 | 0.49 | 13.4 | 12154 | 13.8 | 25 | 61.2 | bainite + fresh M | Yes | 18 | Yes |
| | III | | 414 | 946 | 0.44 | >10.7* | >10122* | 13.3 | 23 | 63.7 | bainite + fresh M | Yes | 9 | Yes |
| F | Ia | | 570 | 970 | 0.59 | 10.3 | 9991 | 13.7 | 28 | 58.3 | bainite + fresh M | Yes | 5 | Yes |
| | Ib | | 589 | 983 | 0.60 | 11.5 | 11305 | 11.4 | 14 | 74.6 | bainite + fresh M | Yes | 10 | Yes |
| G | Ia | | 784 | 1008 | 0.78 | 9.4 | 9475 | 9.5 | 11 | 79.5 | tempered M | No | <2 | Yes |
| H | Ia | | 888 | 1125 | 0.79 | 8.3 | 9338 | 8.6 | 9 | 82.4 | tempered M | No | <2 | No |
| I | Ia | | 840 | 1023 | 0.82 | 8.6 | 8798 | 9.9 | 16 | 74.1 | tempered M + | No | <2 | Yes |
| | | | | | | | | | | | bainite | | | |
| | Ic | | 642 | 956 | 0.67 | 10.3 | 9847 | 8.4 | 17 | 74.6 | tempered M + | No | 4 | Yes |
| | | | | | | | | | | | bainite | | | |
| J | III | | 537 | 1035 | 0.52 | 8.4 | 8694 | 10.0 | 25 | 65.0 | bainite + fresh M | Yes | 31 | Yes |
| K | Ia | | 525 | 985 | 0.53 | 11.5 | 11328 | 9.7 | 33 | 57.3 | fresh M | Yes | 40 | No |
| L | Ia | | 698 | 883 | 0.79 | 8.8 | 7770 | 3.3 | 18 | 78.7 | Bainite | Yes | <2 | No |
| M | Ia | | 571 | 1059 | 0.54 | 9.1 | 9637 | 6.9 | 25 | 68.1 | bainite + fresh M | Yes | 11 | No |
| N | Ia | | 576 | 1085 | 0.53 | 7.6 | 8246 | 6.4 | 26 | 67.6 | bainite + fresh M | Yes | 15 | No |
| O | Ia | | 600 | 972 | 0.62 | 9.7 | 9428 | 10.2 | 20 | 69.8 | bainite + fresh M | Yes | 12 | Yes |
| P | Ia | | 527 | 996 | 0.53 | 10.3 | 10259 | 10.4 | 23 | 66.6 | bainite + fresh M | Yes | 9 | Yes |
| Q | IV | | 810 | 970 | 0.84 | 5.1 | 4947 | 2.6 | <2 | >95 | Bainite | Yes | <2 | No |
| R | IV | | 854 | 1025 | 0.83 | 5.2 | 5330 | 2.1 | <2 | >95 | Bainite | Yes | <2 | No |
| S | IV | | 829 | 993 | 0.83 | 4.6 | 4568 | 2.6 | <2 | >95 | Bainite | Yes | <2 | No |
| T | IV | | 814 | 1118 | 0.73 | 6.2 | 6932 | 7.6 | <2 | >90 | Bainite | Yes | <2 | No |
| U | Id | | 640 | 1047 | 0.61 | 11.1 | 11601 | — | — | — | — | — | — | Yes |
| | Ie | | 669 | 1029 | 0.64 | 10.5 | 10763 | — | — | — | — | — | — | Yes |

In Table 3, the following parameters are noted:
Rₘ: tensile strength
R_{p0.2}⁰: elasticity limit prior to skin pass rolling
R_{p0.2}⁰/Rₘ: yield strength ratio prior to skin pass rolling
A_{g}: uniform elongation
RA: proportion of residual austenite in the microstructure
*A_{g} was determined to be too low (no break according to standards)

Fresh and tempered martensite is shortened to “fresh M” and “tempered M”.

In order to determine the technological characteristic values, tensile tests pursuant to DIN EN ISO 6892-1:2020-06 were performed on samples having a measuring length of 80 mm, taken longitudinally with respect to the rolling direction.

Reference steel A has the required contents of Si, Al and Cr but is not alloyed with Nb and does not meet the prerequisite of μ=4.5×(Si+0.9Al+Cr)+200×Nb>8. In this steel, in particular at low cooling stop temperatures T_{q} no sufficient contents of residual austenite (>8 vol. %) and ferrite (>10 vol. %) could be set in this steel.

Steels B to G, I, J in accordance with the invention have comparable contents of Si, Al and Cr with respect to A and are additionally alloyed with Nb with Nb contents of 130 to 410 ppm. In these steels, μ>8. These steels are also characterised by a content of Si+0.9×Al<1 wt. %. In these steels, high contents of residual austenite >8 vol. % and ferrite >10 vol. % could be achieved. Rₘ×A_{g} was sufficiently high for all annealing cycles with >8000 MPa %. In particular, steels C to F with μ>10 demonstrated in all cycles a very high product of tensile strength and uniform elongation of Rₘ×A_{g}>9000 MPa %.

In steel E with the highest Nb content of 410 ppm and μ=13.8, the highest contents of residual austenite were stabilised. As a result, this steel also achieved the highest values for Rₘ×A_{g}. In this steel, in addition the achieved tensile strength and the content of residual austenite were approximately equal for all annealing cycles with correspondingly different cooling stop temperatures which proves to be advantageous in terms of process stability and process fluctuations for large-scale production. In particular, the content of residual austenite is unexpectedly stable with 13.7%, 13.8% and 13.3% in the range of cooling stop temperatures of 315° C. to 450° C. (annealing cycle Ia, II and III) and permits a constant plasticity brought about by microstructural transformation. Even at lower cooling stop temperatures of 290° C. and 260° C., very high values for Rₘ×A_{g} were possible with a sufficiently high Nb content and μ=12.8 (steel U with annealing cycle Id and Ie).

Reference steel H is likewise alloyed with Nb but has a C content of >0.205 wt. % which is considered to be disadvantageous for welding suitability and LME (liquid metal embrittlement). In addition, owing to the excessive content of C, the hardenability is increased to such an extent that the sufficient amount of ferrite (>10 vol. %) could not be formed in the slow cooling path.

Reference steel K has an excessive content of Al>0.7. For this reason, in this steel no sufficient austenitisation could be ensured in the continuous annealing during the continuous hot-dip galvanisation.

Reference steel L does not meet the prerequisite of μ=4.5×(Si+0.9Al+Cr)+200×Nb>8. In this steel, no sufficient amount of residual austenite could be produced in the microstructure. The tensile strength with annealing cycle Ia was also too low (<900 MPa).

In contrast to the steels in accordance with the invention, reference steels M and N were alloyed with >0.15 wt. % Mo. In these steels, no sufficiently high content of residual austenite could be stabilised because Mo slows the diffusion of the carbon to a large extent and counteracts enrichment of the residual austenite with C. The steels were also not suitable for cold-rolling owing to high rolling forces and a high level of edge cracking susceptibility. Therefore, the Mo content of the steels in accordance with the invention is limited to <0.15 wt. %.

Steels O and P in accordance with the invention have a higher content of Si than steels B to F, G, I, J in accordance with the invention. For these steels, Si+0.9×Al<1.2 wt. %. For steels O and P, sufficient contents of residual austenite and the required technological characteristic values were achieved.

Reference steels Q to S are conventional complex-phase steels with typical low contents (<5 vol. %) of residual austenite in the microstructure prior to the skin pass rolling. For these steels, μ<6 and Rₘ×A_{g} is clearly below 8000 MPa %.

Reference steel T falls below the required Al content of >0.2 wt. % for the embodiment in accordance with the invention and does not reach the required proportion of residual austenite.

These and other features and advantages of the present invention will be apparent using the following examples with reference to the accompanying drawings.

### BRIEF DESCRIPTION OF THE DRAWINGS

FIG. 1 is a graph of the dependency of the technological characteristic values (Rₘ tensile strength, R_{p0.2}⁰ elasticity limit, A_{g} uniform elongation) and the volume content of residual austenite (RA) on the Nb content (steels A to E) after the process step of continuous annealing and hot-dip finishing with temperature cycle Ia;

FIG. 2 shows graphs of the dependency of the volume content of a) residual austenite (RA) and b) the A_{g} uniform elongation of 4.5×(Si+0.9×Al+Cr)+200×Nb (steels A to E) after the process step of continuous annealing and hot-dip finishing with temperature cycle Ia and II;

FIG. 3 is a graph of a relative length change dL/L0 (elongation) measured with a dilatometer as a result of the phase transformation of the austenite for steel F in accordance with the invention and reference steel H during continuous annealing within continuous hot-dip galvanisation for the annealing cycle Ia (cooling in the slow cooling path X1/rapid cooling path X2) in dependence upon the temperature T; and

FIG. 4 discloses a section of a band contrast map (Kikuchi band contrast) measured by electron backscatter diffraction for a region with a) low bainite from steel A with annealing cycle II, and b) granular bainite from steel D with annealing cycle II.

### DESCRIPTION OF THE PREFERRED EMBODIMENTS

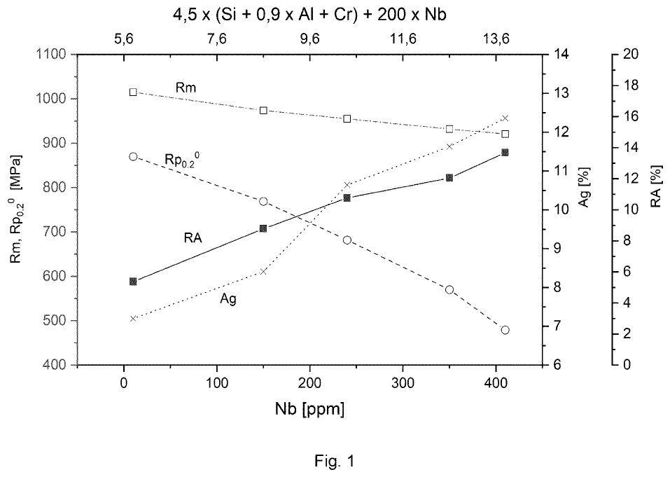

FIG. 1 shows, using the example of steels A to E with annealing cycle Ia, the dependency of the technological characteristic values Rₘ, R_{p0.2}⁰, A_{g} and the content of residual austenite on the Nb content or on 4.5×(Si+0.9×Al+Cr)+200×Nb. As the content of Nb rises, there is, in combination with Si, Al and Cr, a decrease in Rₘ, R_{p0.2}⁰ and an increase in RA and A_{g}. The plasticity brought about by microstructural transformation (increase in RA and A_{g}) increases in an approximately linear manner as the content of μ=4.5×(Si+0.9×Al+Cr)+200×Nb increases. From a content of Nb>100 ppm and μ>8 it is ensured that the steel has a sufficient plasticity brought about by microstructural transformation.

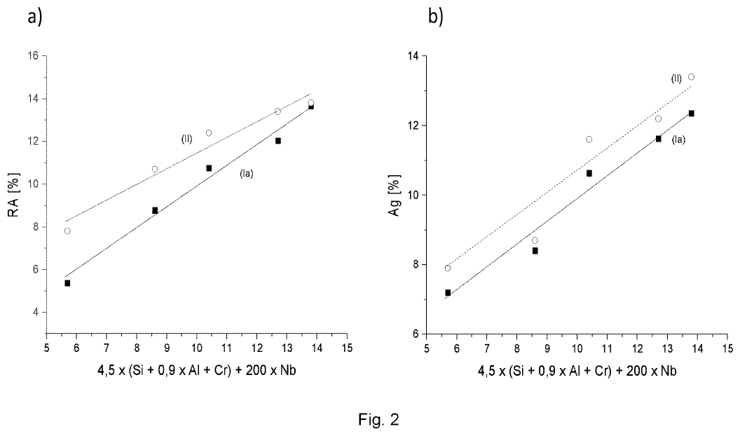

FIG. 2 shows the effect, in accordance with the invention of the content of μ=4.5×(Si+0.9×Al+Cr)+200×Nb for increasing the proportion of residual austenite (FIG. 2a) and the uniform elongation (FIG. 2b) for the annealing cycles Ia and II of the continuous hot-dip galvanisation. As shown in Table 2, the annealing cycles differ by the cooling stop and ageing temperatures of, in each case, 315° C. (cycle Ia) and 400° C. (cycle II). It demonstrated a linearly increasing proportion of residual austenite and uniform elongation as the content of μ=4.5×(Si+0.9×Al+Cr)+200×Nb increased. For μ>8, the uniform elongation is still >8% even for annealing cycle Ia with the lower cooling stop temperature of 315° C. As the content of μ=4.5×(Si+0.9×Al+Cr)+200×Nb increases, the proportions of residual austenite RA come closer together for different cooling stop temperatures, whereby a larger process window is achieved for a constant plasticity brought about by microstructural transformation.

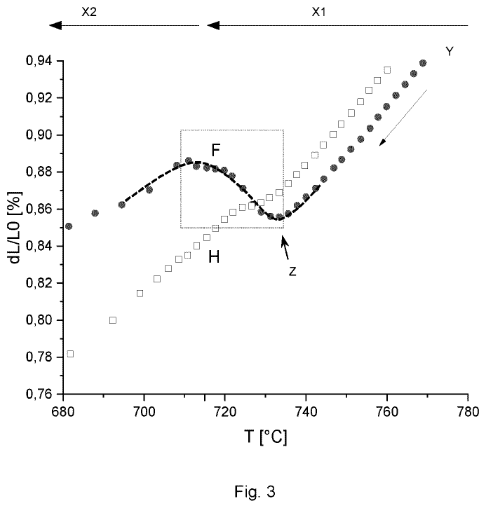

The effect of Nb in the steel in accordance with the invention can be attributed to one or more of the following mechanisms in continuous annealing within continuous hot-dip galvanising: i) suppression of the recrystallisation and hindrance of the grain growth in the austenite at temperatures >750° C.
ii) accelerated formation of ferrite by nucleation on fine Nb precipitations in the slow cooling path and corresponding enrichment of carbon in the austenite (see FIG. 3).

Owing to the accelerated formation of ferrite, operating modes with higher process speeds or a short slow cooling path can thereby be effected, in which the formation of ferrite would not otherwise be possible. Owing to the Nb content, the proportion of ferrite can also be set in a targeted manner, whereby the technological properties can be controlled without modifying the annealing cycle.
iii) lowering of the martensite start temperature by a fine austenite grain, enrichment of carbon beyond (ii) and hindrance of the nucleation of martensite and consequently the possibility of forming fine (granular) bainite with residual austenite as a second phase at low cooling stop temperatures.
iv) grain refinement by delaying the bainite kinetics during ageing and modification of the bainite morphology from slat-like to granular.
v) bringing together the technological properties and the content of residual austenite for different cooling stop temperatures, which produces a wider process window in large-scale production.
vi) higher content of residual austenite in the hot-dip coated steel strip after final cooling to ambient temperature.

FIG. 3 illustrates the transformation behaviour of steel F in accordance with the invention compared with reference steel H during cooling. Starting from the austenite region Y, steel F in accordance with the invention already forms ferrite (ferrite transformation region Z) in the slow cooling path X1 by the increased Nb content from ca. 735° C., and so the remaining austenite is enriched with carbon and in the final microstructure ca. 28 vol. % ferrite is present. In reference steel H, the ferrite formation is greatly suppressed by the high C content and comparatively low content of Nb and the ferrite proportion in the final microstructure is too low at <10 vol. %. The results in Table 3 indicate that preferably ferrite can be formed in the slow cooling path when the following relation applies: (100C+10Mn)/[4.5×(Si+0.9Al+Cr)+200×Nb]<4.5 with the respective alloy contents in wt. %.

Table 4 lists the proportion of specific Σ3 grain boundaries of Nb-containing steels B to E in accordance with the invention in comparison with reference steel A without a targeted addition of Nb.

TABLE 4
Proportions of specific grain boundaries in relation to proportions of the entire grain
boundary surface for large-angle grain boundaries having a disorientation angle >15°. The
proportions of Σ3 grain boundaries were determined with a maximum tolerance of 10°
to the Σ3 orientation relation. The misorientation refers to the orientation relation
or rotation between two grain orientations. The smallest angle of rotation of all cystallographically
equivalent misorientations is referred to as the disorientation angle.

| | | μ = 4.5 × | surface proportion Σ3 | Surface proportion | | |
|---|---|---|---|---|---|---|
| | | (Si + | grain boundaries [%] | grain boundaries | | in accordance |
| Steel | Annealing | 0.9Al + Cr) + | (10° tolerance for | with disorientation | RA | with the |
| no. | cycle | 200 × Nb | Σ3 misorientation) | angle 57-63° [%] | [%] | invention |
| A | Ia | 5.7 | 33.8 | 45.0 | 5.4 | No |
| | II | | 41.5 | 51.1 | 7.8 | No |
| B | Ia | 8.6 | 24.0 | 32.7 | 8.8 | Yes |
| | II | | 20.1 | 28.5 | 10.7 | Yes |
| C | Ia | 10.4 | 22.8 | 31.1 | 10.8 | Yes |
| | II | | 15.8 | 23.0 | 12.4 | Yes |
| D | Ia | 12.7 | 20.8 | 28.9 | 12.1 | Yes |
| | II | | 15.7 | 23.2 | 13.4 | Yes |
| E | Ia | 13.8 | 18.3 | 25.7 | 13.7 | Yes |
| | II | | 14.4 | 21.3 | 13.8 | Yes |

The individual grain orientations of the microstructure were measured by means of electron backscatter diffraction (EBSD), which produces the misorientations of the grain boundaries. Misorientation is understood to mean the orientation relation between two grains. With an increasing content of μ=4.5×(Si+0.9Al+Cr)+200×Nb, the proportion of coherent Σ3 grain boundaries is reduced (in relation to proportions of the entire grain boundary surface for large-angle grain boundaries having a disorientation angle >15°, wherein the length proportions, measured with EBSD, of grain boundaries in the EBSD map are typically adopted as surface proportions of the grain boundaries). In the present case, a grain boundary is defined as a Σ3 grain boundary when its misorientation deviates by at most 10° from the precise misorientation 60° <111>. The reduction in the proportion of Σ3 grain boundaries is also associated with a reduction in the proportion of grain boundaries having a disorientation angle in the range 57-63° (table 4), which are typically observed as a characteristic 60° peak in the disorientation angle distribution in multiphase steels. Such specific Σ3 grain boundaries are produced, inter alia, when lower bainite (parallel bainite slats) are produced or solid martensite slats are formed even prior to entering the ageing zone.

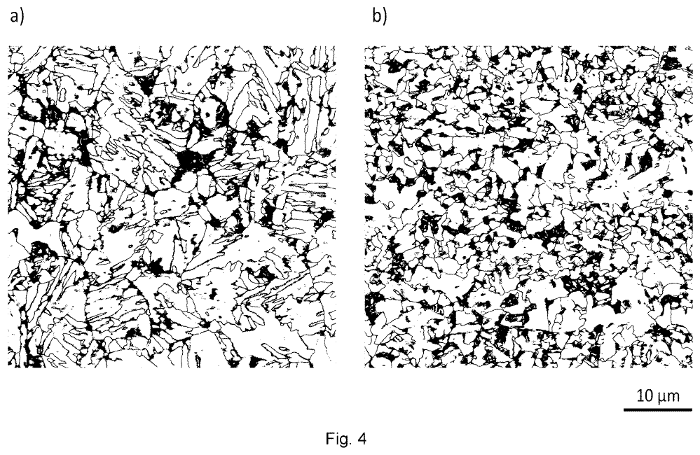

FIG. 4 shows a section of a band contrast map (Kikuchi band contrast) measured by means of electron backscatter diffraction for a region with a) low bainite from steel A with annealing cycle II and a region with b) granular bainite from steel D with annealing cycle II. Dark regions characterise grain boundaries and grains with a higher dislocation density.

It was observed that in the steel in accordance with the invention with an increasing content of elements corresponding to the value μ, the microstructure development of tempered martensite and/or lower bainite (FIG. 4a) is displaced in the direction of a fine granular bainite (FIG. 4b). The granular bainite is characterised, owing to a weakly pronounced variant selection, by a lower number of Σ3 grain boundaries (weak 60° peak in the disorientation angle distribution), see article “S. Zajac, V. Schwinn, K.-H. Tacke; Mater. Sci. Forum 500-501 (2005) 387-394”. The advantage of this type of bainite resides in the fact that the granular bainite, caused by its production mechanism, results in the formation of a carbon-rich second phase. If the carbon concentration of this second phase is high enough, the residual austenite is stabilised. For this reason, in the steel in accordance with the invention it is advantageous to set a lower proportion of Σ3 grain boundaries in the final microstructure. In order to stabilise the highest possible contents of residual austenite and to be able to use low cooling stop temperatures, a proportion of Σ3 grain boundaries of <30% is advantageous in the steel in accordance with the invention.

1. A method for producing a hot-dip coated high-strength steel strip with plasticity brought about by microstructural transformation, comprising the following steps:
producing a hot-rolled steel strip consisting of the following elements in wt. %:
C: from 0.15 to 0.205,
Mn: from 1.9 to 2.6,
Al: from 0.2 to 0.7,
Si: from 0.5 to 0.9,
Cr: from 0.2 to 0.5,
Nb: from 0.01 to 0.06,
Mo: <0.15,
B: ≤0.001,
P: ≤0.02,
S: ≤0.005,
and optionally one or more of the following elements in wt. %:
Ti: 0.005 to 0.060,
V: 0.001 to 0.060,
N: 0.0001 to 0.016,
Ni: 0.01 to 0.5 and
Cu: 0.01 to 0.3,
with the remainder being iron including typical steel-associated elements, wherein for a value μ=4.5×([Si]+0.9×[Al]+[Cr])+200×[Nb], in which [Si], [Al], [Cr] and [Nb] are the proportions of the corresponding elements in wt. %, 8≤μ≤16;
acid-cleaning and optionally cold-rolling the hot-rolled steel strip to form a cold-rolled steel
subsequently continuously annealing during a continuous hot-dip coating process of the cold- or hot-rolled steel strip at a maximum temperature between 750° C. to 950° C. inclusive for the total duration of 10 s to 1200 s;
subsequently cooling the cold- or hot-rolled steel strip to an intermediate temperature in a temperature range of 620 to 760° C. at an average cooling rate CR₁ of up to 10 K/s;
subsequently further cooling the cold- or hot-rolled steel strip from the intermediate temperature to a cooling stop temperature in a temperature range between 200° C. and 450° C. inclusive at an average cooling rate CR₂>CR₁ and at most 150 K/s and then maintaining the temperature in the temperature range between 200° C. and 450° C. inclusive for 25 to 500 s;
subsequently hot-dip coating the cold- or hot-rolled steel strip at a temperature between 380 and 500° C.; and
subsequently finally cooling the hot-dip coated cold- or hot-rolled steel strip at an average cooling rate of 1 K/s to 50 K/s to ambient temperature.

2. The method as claimed in claim 1, wherein 10≤μ≤16 applies for the value μ and the expression [Si]+0.9×[Al]<1.2 applies, wherein [Si] and [Al] are the proportions of the corresponding elements in wt. % on the hot-rolled steel strip.

3. The method as claimed in claim 1, wherein in the hot-rolled steel strip the content of Nb in ppm is >200.

4. The method as claimed in claim 1 wherein the proportion of Mn on the hot-rolled steel strip is between 1.95 and 2.4 wt. %, and the proportion of C on the hot-rolled steel strip is at least 0.16 wt. %

5. The method as claimed in claim 1, wherein the sum of the proportions of the elements Cr and Mo on the hot-rolled steel strip in wt. % is less than 0.5 as expressed by [Cr]+[Mo]<0.5.

6. The method as claimed in claim 1, wherein the intermediate temperature is in a temperature range of 650 to 730° C. and the steel strip has, when this temperature is reached, a microstructure having at least 10 vol. % ferrite.

7. The method as claimed in claim 1, wherein the cooling stop temperature is ≤400° C., and after the final cooling to ambient temperature more than 8 vol. % austenite is present in the microstructure, wherein the temperature at which the cold- or hot-rolled steel strip is kept prior to the hot-dip coating is ≤400° C.

8. The method as claimed in claim 1, wherein the hot-dip coated high-strength steel strip has a tensile strength Rₘ of at least 900 MPa and a uniform elongation A_{g} of at least 8%.

9. The method as claimed in claim 1, wherein the hot-dip coated steel strip is subjected to skin pass rolling with a rolling degree of at most 2%, wherein the R_{p0.2} elasticity limit increases by at least 20 MPa owing to the skin pass rolling.

10. The method as claimed in claim 1, wherein in the case of the hot-rolled steel strip the content of Ti is at least 0.005 wt. %, the content of N is at most 0.008 wt. %, the content of Al is at most 0.5 wt. % and TiN and TiAlN particles having a diameter of >0.96 μm are present in total in a surface proportion of at least 1 μm²/mm² on a measuring surface of at least 100 mm² in a slab prior to re-heating and on a measuring surface of at least 20 mm² in the hot-dip coated high-strength steel strip.

11. (canceled)

12. (canceled)

13. (canceled)

14. (canceled)

15. (canceled)

16. A method for producing a hot-dip coated high-strength steel strip with plasticity brought about by microstructural transformation, comprising the following steps:
producing a hot-rolled steel strip from a slab heated to above 1200° C. consisting of the following elements in wt. %:
C: from 0.15 to 0.205,
Mn: from 1.9 to 2.6,
Al: from 0.2 to 0.7,
Si: from 0.5 to 0.9,
Cr: from 0.2 to 0.5,
Nb: from 0.01 to 0.06,
Mo: <0.15,
B: ≤0.001,
P: ≤0.02,
S: ≤0.005,
and optionally one or more of the following elements in wt. %:
Ti: 0.005 to 0.060,
V: 0.001 to 0.060,
N: 0.0001 to 0.016,
Ni: 0.01 to 0.5 and
Cu: 0.01 to 0.3,
with the remainder being iron including typical steel-associated elements, wherein for a value μ=4.5×([Si]+0.9×[Al]+[Cr])+200×[Nb], in which [Si], [Al], [Cr] and [Nb] are the proportions of the corresponding elements in wt. %, 8≤μ≤16;
acid-cleaning and optionally cold-rolling the hot-rolled steel strip to form a cold-rolled steel strip;
subsequently continuously annealing during a continuous hot-dip coating process of the cold- or hot-rolled steel strip at a maximum temperature between 80° and 870° C. for the total duration of 50 s to 650 s;
subsequently cooling the cold- or hot-rolled steel strip to an intermediate temperature in a temperature range of 620 to 760° C. at an average cooling rate CR₁ of up to 10 K/s;
subsequently further cooling the cold- or hot-rolled steel strip from the intermediate temperature to a cooling stop temperature in a temperature range between 280° C. and 450° C. inclusive, at an average cooling rate CR₂>CR₁ and at most 150 K/s and then maintaining the temperature in the temperature range between 280° C. and 450° C. inclusive, for 25 to 500 s;
subsequently hot-dip coating the cold- or hot-rolled steel strip at a temperature between 38° and 500° C.; and
subsequently finally cooling the hot-dip coated cold- or hot-rolled steel strip at an average cooling rate of 1 K/s to 50 K/s to ambient temperature.

17. The method as claimed in claim 16, wherein 10≤μ≤16 applies for the value μ and the expression [Si]+0.9×[Al]<1.0 applies, wherein [Si] and [Al] are the proportions of the corresponding elements in wt. % on the hot-rolled steel strip, and wherein in the hot-rolled steel strip the content of Nb in ppm is >300.

18. The method as claimed in claim 17, wherein the proportion of Mn on the hot-rolled steel strip is between 1.95 and 2.4 wt. %, the proportion of C on the hot-rolled steel strip is at least 0.16 wt. %, and the expression (100 [C]+10 [Mn])/(4.5×([Si]+0.9+[Cr])+200×[Nb])<4.5 applies, wherein [Si], [Al], [Cr], [C] and [Mn] are the proportions of the corresponding elements on the hot-rolled steel strip in wt. %, and wherein the sum of the proportions of the elements Cr and Mo on the hot-rolled steel strip in wt. % is less than 0.5 as expressed by [Cr]+[Mo]<0.5, and wherein the intermediate temperature is in a temperature range of 650 to 730° C. and the steel strip has, when this temperature is reached, a microstructure having at least 10 vol. % ferrite.

19. The method as claimed in claim 18, wherein the cooling stop temperature is ≤350° C., and after the final cooling to ambient temperature more than 8 vol. % austenite is present in the microstructure, wherein the temperature at which the cold- or hot-rolled steel strip is kept prior to the hot-dip coating is ≤350° C., and wherein the hot-dip coated high-strength steel strip has a tensile strength Rₘ of at least 900 MPa and a uniform elongation A_{g} of at least 8%.

20. The method as claimed in claim 19, wherein the hot-dip coated steel strip is subjected to skin pass rolling with a rolling degree of at most 2%, wherein the R_{p0.2} elasticity limit increases by at least 20 MPa owing to the skin pass rolling, and wherein in the case of the hot-rolled steel strip the content of Ti is at least 0.005 wt. %, the content of N is at most 0.008 wt. %, the content of Al is at most 0.5 wt. % and TiN and TiAlN particles having a diameter of >0.96 μm are present in total in a surface proportion of at least 1 μm²/mm² on a measuring surface of at least 100 mm² in the slab prior to re-heating and on a measuring surface of at least 20 mm² in the hot-dip coated high-strength steel strip.

21. A hot-dip coated high-strength steel strip with a plasticity brought about by microstructural transformation produced by a method as claimed in claim 1, consisting of the following elements in wt. %:
C: from 0.15 to 0.205,
Mn: from 1.9 to 2.6,
Al: from 0.2 to 0.7,
Si: from 0.5 to 0.9,
Cr: from 0.2 to 0.5,
Nb: from 0.01 to 0.06,
Mo: <0.15,
B: ≤0.001,
P: ≤0.02,
S: ≤0.005,
and optionally one or more of the following elements in wt. %:
Ti: 0.005 to 0.060,
V: 0.001 to 0.060,
N: 0.0001 to 0.016,
Ni: 0.01 to 0.5 and
Cu: 0.01 to 0.3,
with the remainder being iron including typical steel-associated elements, wherein for a value μ=4.5×([Si]+0.9×[Al]+[Cr])+200×[Nb], in which [Si], [Al], [Cr] and [Nb] are the proportions of the corresponding elements in wt. %, 8≤μ≤16, wherein the steel strip has a product of Rₘ tensile strength and uniform elongation A_{g} of greater than 8000 MPa %, in particular greater than 9000 MPa %, and particularly advantageously between 9900 to 13000 MPa %.

22. The hot-dip coated high-strength steel strip as claimed in claim 21, wherein the steel strip has a product of Rₘ tensile strength and uniform elongation A_{g} of between 9900 to 13000 MPa %.

23. The hot-dip coated high-strength steel strip as claimed in claim 21, wherein the surface proportion of specific Σ3 grain boundaries having a maximum deviation of 10° to the Σ3 orientation relation of 60° <111>, relating to the overall grain boundary surface for large-angle grain boundaries having a disorientation angle >15°, is less than 30%.

24. The hot-dip coated high-strength steel strip as claimed in claim 21, wherein the steel strip has a yield strength ratio R_{p0.2}/Rₘ of <0.87 and a bake-hardening value BH2 of ≥25 MPa.

25. The hot-dip coated high-strength steel strip as claimed in claim 21, wherein the microstructure of the hot-dip coated high-strength steel strip comprises at least the following components: 8-16 vol. % residual austenite, >10 and <40 vol. % ferrite, at least a sum of 50 vol. % of bainite, tempered martensite and fresh martensite.

26. The hot-dip coated high-strength steel strip as claimed in claim 25, wherein the microstructure of the hot-dip coated high-strength steep strip has at least two of the following properties:
the proportion of bainite and fresh martensite in vol. % is, in total, greater than the proportion of tempered martensite in vol. %;
with regard to the bainite, the proportion of granular bainite in vol. % is higher than the proportion of lower bainite in vol. %; and
there is a proportion of at least 2 vol. % of fresh martensite in the total microstructure.
